(19) United States
(12) Patent Application Publication
(10) Pub. No.: US 2024/0185442 A1
(43) Pub. Date: Jun. 6, 2024

(54) MONOCULAR DEPTH ESTIMATION

(71) Applicant: Zimeno Inc., Livermore, CA (US)

(72) Inventor: Sanket GOYAL, Pleasanton, CA (US)

(73) Assignee: Zimeno Inc., Livermore, CA (US)

(21) Appl. No.: 18/388,822

(22) Filed: Nov. 11, 2023

Related U.S. Application Data
(60) Provisional application No. 63/526,240, filed on Jul. 12, 2023.
(60) Provisional application No. 63/429,158, filed on Dec. 1, 2022.

(51) Int. Cl. G06T 7/55; G05D 1/02; G06T 7/246; G06T 7/73

(52) U.S. Cl. CPC G06T 7/55; G05D 1/0251; G05D 1/027; G05D 1/0278; G06T 7/248; G06T 7/74; G06T 2207/30261; H04N 23/90

(57) ABSTRACT

A first monocular image and a second monocular image are captured from a vehicle. The first monocular image is from a first vantage point and contains a subject at a location. The second monocular is from a second vantage point, different than the first vantage point, and contains the subject at the location. A first initial estimate of coordinates of the location is determined based upon the first monocular image. A second initial estimate of coordinates of the location is determined based upon the second monocular image. A final estimate of coordinates of the location is determined based upon the first initial estimate, the second initial estimate and a distance between the first vantage point and the second vantage point.

### CROSS-REFERENCE TO RELATED APPLICATIONS

The present non-provisional application claims priority from co-pending U.S. provisional patent Application Ser. No. 63/429,158 filed on Dec. 1, 2022, by Sanket Goyal and entitled MONOCULAR DEPTH ESTIMATION, and co-pending U.S. provisional patent Application Ser. No. 63/526,240 filed on Jul. 12, 2023, by Sanket Goyal and entitled VEHICLE CONTROL, the full disclosures of which are hereby incorporated by reference.

### BACKGROUND

Vehicles must often avoid various obstacles during travel. Such obstacles may be stationary or may be moving. Such obstacles may be in the form of humans, animals, or plants. Such obstacles may be isolated or may be arranged in rows, such as crop, orchard or vineyard rows.

### BRIEF DESCRIPTION OF THE DRAWINGS

FIG. 1 is a diagram schematically illustrating portions of an example monocular depth estimation system.

FIG. 2 is a flow diagram of an example monocular depth estimation method.

FIG. 3A is a diagram of an example image of an example subject at a location and captured from a first vantage point.

FIG. 3B is a diagram of an example image of the example subject of FIG. 3A at the location and captured from a second vantage point.

FIG. 4A is a diagram of an example image of the example subject at a second location captured from a first vantage point.

FIG. 4B is a diagram of an example image of the example subject of FIG. 4A at the second location captured from a second vantage point.

FIG. 5 is a diagram illustrating an example perspective-n-point computational system for estimating coordinates of a location of the subject.

FIG. 6 is a diagram illustrating an example computation of the example perspective-n-point computation system of FIG. 5.

FIG. 7 is a diagram illustrating an example computation of the example perspective-n-point computation system of FIG. 5.

FIG. 8 is a perspective view of an example camera intrinsic matrix for use by the example perspective-n-point computation system of Figure five.

FIG. 9 is a diagram schematically illustrating portions of an example monocular depth estimation system.

FIG. 10 is a diagram schematically illustrating portions of an example monocular depth estimation system.

FIG. 11 is a flow diagram of an example monocular depth estimation method.

FIG. 12 is a diagram schematically illustrating portions of an example monocular depth estimation system with and example vehicle at a first position.

FIG. 13 is a diagram schematically illustrating portions of the example monocular depth estimation system of FIG. 12 with the example vehicle at a second position.

FIG. 14 is a flow diagram of an example monocular depth estimation method.

FIG. 15 is a perspective view of an example monocular depth estimation system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example monocular depth estimation systems, methods and computer-readable mediums that assist in determining the distance separating the vehicle from a potential obstacle. The example systems, methods and mediums assist in determining the proper steering and speed of the vehicle to avoid such obstacles or to properly interact with such obstacles. In some circumstances, the example systems, methods and mediums assist in alerting the operator of the vehicle and/or the obstacle (subject) of the potential future encounter or collision such that remedial action may be taken. The example systems, methods and mediums provide such vehicle to obstacle/subject depth estimations using monocular images. As result, such depth estimations may be achieved with lower hardware demands, with lower computing power, and in real time.

Disclosed are example monocular depth estimation systems, methods and computer-readable mediums that may facilitate enhanced location (position or distance/depth) estimates for subjects relative to a vehicle using monocular camera images. Such subjects may be obstructions, persons, other vehicles, or animals for which collision is to be avoided. Such subjects may be stationary, such as rows of crops, trees, vines and the like. Such subjects may be moving and temporary in nature.

The example systems, methods and mediums capture a first monocular image and a second monocular image from a vehicle. The first monocular image is from a first vantage point and contains a subject at a location. The second monocular is from a second vantage point, different than the first vantage point, and contains the subject at the location.

A “vantage point” is the position and angle from which the image is captured or taken. Different vantage points may be from a single camera that has been moved so as to be at different locations/orientations when the first and second monocular images are captured. Different vantage points may be from different spaced apart cameras which capture the first and second monocular images at the same time or without movement of the cameras between the capture of the first and second monocular images. Different vantage points may be from different spaced apart cameras at different times and following movement of such cameras, wherein a first camera captures the first monocular image while the first and second cameras are at first positions and wherein a second camera captures the second monocular image while the first and second cameras are at second different positions.

The example systems, methods and mediums determine a first initial estimate of coordinates of the location based upon the first monocular image. The example systems, methods and mediums determine a second initial estimate of coordinates of the location is determined based upon the second monocular image. The example systems, methods and mediums determine a final estimate of coordinates of the location is determined based upon the first initial estimate, the second initial estimate and a distance between the first vantage point and the second vantage point.

In some implementations, the example systems, methods and mediums capture multiple monocular images of the subject while at a single location with different cameras supported by the vehicle or the same camera supported by the vehicle at different vehicle locations. The monocular images may be captured with monocular cameras or stereo cameras (3D cameras) operating in a monocular mode. Initial estimates for the coordinates of the location of the subject are determined for each of the different monocular images. A final estimate of the coordinates of the location of the subject is then determined based upon each of the initial estimates and either the predetermined distance between the different cameras or the determined distance between the positions of the camera at the different vehicle locations when the monocular images were taken by the same camera. In some input taste, the final estimate of the coordinates of the location of the subject is determined based upon each of the initial estimates and either the predetermined distance between the different cameras or the determined distance between the positions of the camera at the different vehicle locations when the monocular images were taken by the same camera using triangulation.

In some implementations, the final estimate of the coordinates of the location of the subject is adjusted based upon at least one of a roll and/or yaw of the vehicle. In some implementations, the vehicle of the system may include a measurement unit carried by the vehicle to provide the roll or yaw of the vehicle.

In some implementations, the final estimate of the coordinates of the location of the subject may be adjusted based upon an estimate of the motion of the subject or the expected motion of the vehicle relative to the subject. For example, the estimated motion of the subject may be based upon the final estimate of the coordinates and an earlier final estimate of the coordinates, indicating the direction and speed in which the subject may be moving. The estimated motion of the vehicle may be based upon a planned or programmed motion of the vehicle (such as when the vehicle is operating according to a routine or preprogrammed route in an autonomous fashion) or sensed motion of the vehicle. The sensed motion of the vehicle may be determined based upon signals from wheel odometry (wheel encoders) and steering signals, visual odometry based upon signals from one or more cameras over time, and/or based upon signals from a global positioning satellite (GPS) system receiver carried by the vehicle.

In some implementations, the final estimate of the coordinates of the location of the subject are continuously determined and utilized to monitor relative positioning of subject to the vehicle so as to properly control the vehicle to avoid collisions and the like or to output warning signals or notification to an operator the vehicle or the subject itself. In some implementations, the final estimate of the coordinates of the subject are determined in a discontinuous fashion. For example, the final estimate of the coordinates of subject may be determined periodically or at selected times chosen by the operator or based upon the particular type or characteristics of an operation currently or about to be performed by the vehicle. For example, in response to receiving a command from an operator or in accordance with a programmed routine for a particular operation or action, a controller may trigger the process for determining the final estimate of the coordinates of the location of the subject or positioning or spacing of subject relative to the vehicle. The determination of the final estimate of the coordinates of the location of the subject may be determined in “real-time”. For purposes of this disclosure, the term “real-time” means that the images being used to determine the final estimate are being provided at a rate of at least 10 frames per second. In particular implementations, the provision of images at slower speeds may cause issues in accurate triangulation of a bounding box containing the subject which may reduce accuracy or result in the vehicle being stopped or adjusted at an unsafe distance from the subject.

Various operations may be controlled or adjusted based upon the final estimate of the coordinates of the location of the subject, with or without adjustment based upon roll, pitch, subject motion or vehicle motion. For example, an operator of the vehicle may be provided with an alert notifying the operator that the subject is in close proximity to the vehicle. An alert may additionally or alternatively be provided to the subject itself, recommending movement of the subject. The speed or braking of the vehicle may be adjusted autonomously based upon the final estimate of the coordinates of the subject. The steering of the vehicle may be autonomously controlled or adjusted based upon the final estimate of the coordinates of the subject. The positioning of an attachment or implement carried by the vehicle may be adjusted based upon the final estimate (adjusted or unadjusted) of the coordinates of the subject. For example, the attachment be moved to the left, to the right, may be raised or may be lowered based upon the positioning of the subject. The operation of the attachment or implement itself may be adjusted based upon the final estimate (adjusted or unadjusted) of the coordinates of the subject. For example, the power takeoff on a vehicle may be increased or reduced in speed to adjust the speed at which the attachment or implement is interacting with the environment. A spray pattern of a sprayer may be widened or reduced based upon the position of the subject.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members. The term “fluidly coupled” shall mean that two or more fluid transmitting volumes are connected directly to one another or are connected to one another by intermediate volumes or spaces such that fluid may flow from one volume into the other volume.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

FIG. 1 is a diagram schematically illustrating portions of an example monocular depth estimation system 1920. System 1920 comprises vehicle 1924, cameras 1928-1, 1928-2 (collectively referred to as cameras 1928), and controller 1940. Vehicle 1924 is configured to be pushed, pulled or self-propelled. Vehicle 1924 may be in the form of a tractor, a truck, a passenger vehicle, or other forms of a self-propelled motorized vehicle. Vehicle 1924 may be steered by an operator locally residing on the vehicle, by a remote operator or in an autonomous fashion based at least in part upon a program or routine.

Cameras 1928 are supported at different positions on or by vehicle 1924. In the example illustrated, system 1920 comprises two cameras 1928-1 and 1928-2 facing in a forward direction proximate a front of vehicle 1924, wherein the cameras 1928 have overlapping fields of view 1932 and 1934, respectively. In other implementations, cameras 1928 may be provided at other locations on vehicle 1924, wherein the cameras have overlapping fields of view. For example, cameras 1928 may alternatively be rearwardly facing cameras or sideways facing cameras. In some implementations, system 1920 may comprise additional cameras which also have overlapping fields of view.

Controller 1940 receives signals from cameras 1928 and processes such signals to determine a final estimate of the coordinates of an example subject 1950 (schematically illustrated). Thereafter, in some implementations, controller 1940 may further control or adjust the operation of vehicle 1924 and/or associated attachments/implements based upon the final estimate of the coordinates of the example subject 1950. Controller 1940 comprises processor 1956 and memory 1958.

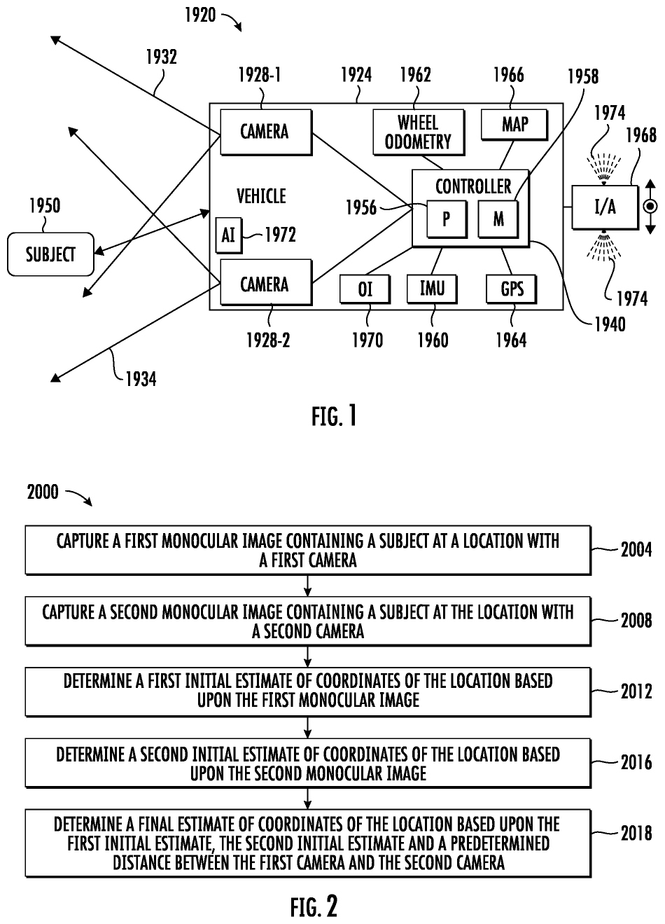

Processor 1956 comprises a processing unit configured to carry out calculations and potentially output control signals pursuant to instructions contained in memory 1958. Memory 1958 comprises a non-transitory computer-readable medium containing instructions for directing processor 1956 to carry out calculations and output control signals. Instructions in memory 1958 direct processor 1956 to carry out the example monocular depth estimation method 2000 shown in the flow diagram of FIG. 2.

As indicated by block 2004, instructions in memory 1958 direct processor 1956 to cause camera 1928-1 to capture a first monocular image containing subject 1950 at a particular location. As indicated by block 2008, instructions in memory 1958 direct processor 1956 to cause camera 1928-2 to capture a second monocular image containing the subject 1950 at the same particular location. In other words, the monocular images captured by cameras 1928 are taken at the same time at times where vehicle 1924 and subject 1950 are at the same positions or locations.

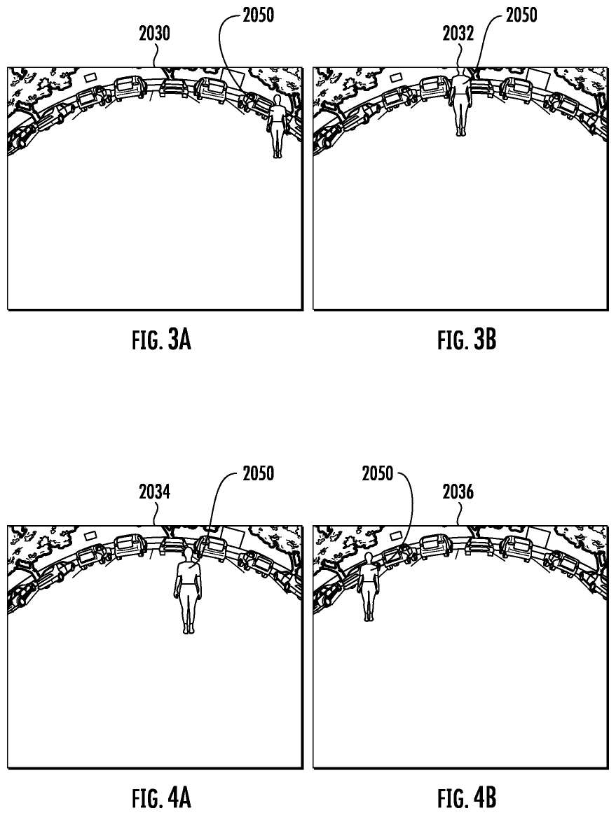

FIG. 3A is an example of a first monocular image 2030 captured by camera 1928-1 of an example subject 2050 at a first location. FIG. 9B is an example of a second monocular image 2032 of the same example subject 2050 at the same first location, captured by camera 1928-2. The particular subject may alternatively be any of the individual cars or rows of cars depicted in the two monocular images. In some implementations, each of the two monocular images 2030, 2032 may contain multiple subjects for which depth estimates or location estimates are to be determined. FIGS. 4A and 4B are examples of monocular images 2034 and 2036 captured by cameras 1928-1 and 1928-2, respectively, of the example subject 2050 at a particular location.

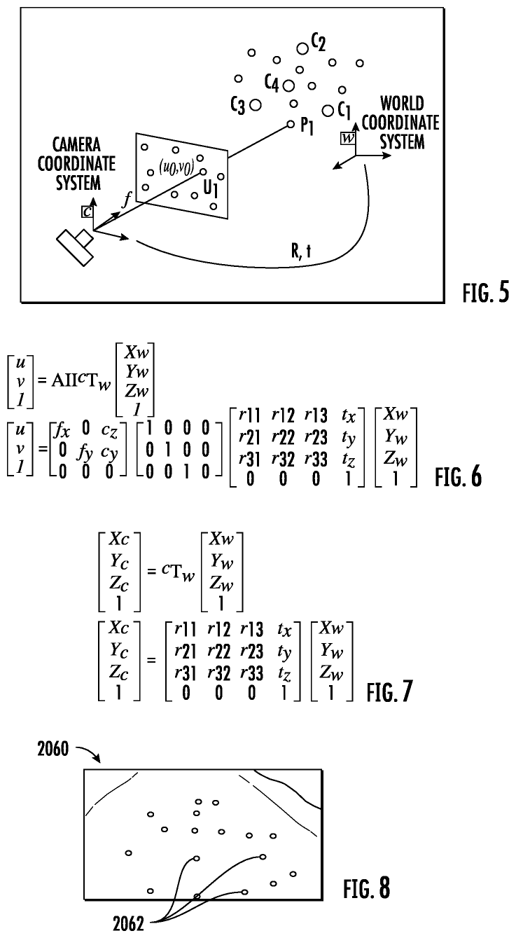

As indicated by block 2012 in FIG. 2, controller 1940 (processor 1956 following instructions in memory 1958) determines a first initial estimate of the coordinates of location of the subject based upon the first monocular image captured by camera 1928-1. FIGS. 5, 6 and 7 illustrate an example of how initial estimates of the coordinates of the location of subject 1950 may be determined based upon a monocular image. With respect to FIG. 5, an open source implementation of Perspective-n-Point, such as a SolvePnP function, and related functions estimate the object pose given a set of object points, their corresponding image projections, as well as the camera intrinsic matrix and the distortion coefficients (shown below). More precisely, the X-axis camera frame is pointing to the right, the Y-axis is pointing downward, and the Z-axis is pointing forward. With respect to FIG. 6, points expressed in the world frame Xw are projected onto the image plane [u, v] using the perspective projection model Il and the camera intrinsic parameters matrix A (also denoted K in the literature). With respect to FIG. 7, the estimated pose is thus the rotation (rvec) and the translation (tvec) vectors that allow transforming a 3D point expressed in the world frame into the camera frame. As shown by such figures, a SolvePnP (a perspective-n-point (PnP) computation) and related functions are used to estimate the object pose given a set of object points, the corresponding image projections as well as cameras intrinsic matrix and distort coefficients.

FIG. 8 is a perspective view illustrating an example camera intrinsic matrix 2060 with various locations depicted by cones 2062 or other markers at predetermined spaced locations from the particular camera on the vehicle 1924. These markers 2062 define the camera coordinate system depicted in FIG. 5. In other implementations, other pose estimation functions or mathematical processes may be used to determine the first initial estimate (and/or the second initial estimate).

As indicated by block 2016 in FIG. 2, controller 1940 determines a second initial estimate of the coordinates of the location of the subject 1950 based upon the second monocular image received from camera 1928-2. The second initial estimate of the coordinates may be determined in a fashion similar to the fashion described above in FIGS. 5-8 and used to determine the first initial estimate of coordinates. The two initial estimates of the coordinates of the location of subject 1950, based upon different monocular images from different cameras at different angles or vantage points, serve as a basis for a final, potentially more accurate, estimate of the coordinates or depth of subject 1950.

As indicated by block 2018 in FIG. 2, controller 1940 determines a final estimate of the coordinates of the location of the subject 1950 based upon the first initial estimate determined in block 2012 based upon (1) the monocular image from camera 1928, (2) the second initial estimate determined in block 2016 based upon the monocular image from camera 1930, and (3) the predetermined distance and relative locations of cameras 1928-1 and 1928-2. In some implementations, triangulation may be used to determine the final estimate based upon the initial estimates and the predetermined distance/relative locations of cameras 1928-1 and 1928-2. In some implementations, the final estimate may be determined based upon more than two monocular images from more than two cameras and their known relative positions.

As shown by FIG. 1, in some implementations, system 1920 may additionally comprise inertial measurement unit 1960, wheel odometry 1962 and GPS receiver 1964. Each of such components facilitate an adjustment to the final estimate for the coordinates of the location of subject 1950 as determined in block 2018 of FIG. 8. Inertial measurement unit 1960 may comprise accelerometers and a gyroscope. Inertial measurement unit 1960 may output signals indicating a current roll, pitch and/or yaw of vehicle 1924. Instructions in memory 1958 may direct processor 1956 to determine the roll, pitch and/or yaw of vehicle 1924 at the time of the capture of the monocular images by cameras 1928 and 1930 and to adjust the final estimate for the coordinates of the location of subject 1950 based upon the roll, pitch and/or yaw of vehicle 1924 at the time of image capture. In some implementations, this adjustment may comprise adjusting the first and the second initial estimates determined in block 2012 and 2016 based upon the then roll, pitch and/are yaw of vehicle 1924 and determining a new final estimate using the adjusted first and second initial estimates. In some implementations, this adjustment may comprise directly adjusting the previously determined final estimate based upon the roll, pitch and/or yaw of vehicle 1924 at the time of image capture. In some implementations, system 1920 may utilize more than one inertial measurement unit for providing signals roll, pitch or yaw of vehicle 1924. In some implementations, inertial measurement unit 1960 may be omitted.

Wheel odometry 1962, GPS 1964 and images provided by cameras 1928 at different points in time, may further be utilized by controller 1940 to determine or estimate motion of vehicle 1924. Such motion of vehicle 1924 may have occurred following the capture of the first and second monocular images in blocks 2004 and 2008. Such motion may impact the relative spacing or depth of subject 1954 with respect to vehicle 1924. For example, the final estimate determined in block 2018 may indicate that subject 1950 is at a first distance from vehicle 1924. However, subsequent motion of vehicle 1924 may result in subject 1950 being closer or farther away from vehicle 1924. Based upon the determined motion of vehicle 1924 following the final estimate determination in block 2018, controller 1940 may adjust an estimated spacing or depth of subject 1950. This adjustment may result in more appropriate timely vehicle responses based upon the adjusted depth or location of subject 1950 relative to vehicle 1924.

In some implementations, in lieu of sensing vehicle motion following the final estimate determined in block 2018, controller 1940 may adjust an estimated depth of subject 1950 or spacing of subject 1950 from vehicle 1924 based upon an autonomous program or routine that is controlling the steering and speed of vehicle 1924. For example, vehicle 1924 may be autonomously driven on a particular predefined course and at a particular predefined speed or set of speeds pursuant to a routine or program contained in memory 1958 or received by controller 1940 from a remote location. The program or routine may control the steering speed of vehicle 1924 based on elapsed time since the beginning of the routine or the current geographic location of vehicle 1924, as determined from signals from GPS 1964. Using such information, controller 1940 may determine or estimate the distance and direction traveled by vehicle 1924 for the period of time following the final estimate determination in block 2018. The distance and direction traveled by vehicle 1924 in combination with the earlier determined final estimate determined in block 2018 may be utilized by controller to determine the actual current spacing or relative positioning of subject 1950 with respect to vehicle 1924.

In response to or based upon the current coordinates of subject 1950 and/or the current spacing or relative positioning of subject 1950 with respect to vehicle 1924, instructions in memory 1958 may direct processor 1956 to carry out any one of multiple various responsive actions, such as mapping, steering and/or speed adjustments, operational adjustments and/or notifications/alerts, As schematically shown in FIG. 1, system 1920 may additionally comprise map 1966, implement/attachment 1968, operator interface 1970 and alert interface 1972.

In some implementations, upon determining the estimated coordinates for the location of subject 1950, controller 1940 may map such coordinates, resulting in map 1966. In case of subject 1950 may be or permanent in nature or not subject to change, such mapping may be useful for subsequent control of vehicle 1924 at future times. Map 1966 may be stored either locally on vehicle 1924 or at a remote location, wherein the coordinates and/or the map are transmitted in a wireless fashion to a remote server. In some implementations, such mapping may be omitted.

In response to or based upon the final estimate and/or the current estimate for the relative positioning of subject 1950 with respect to vehicle 1924, controller 1940 may automatically adjust the current course and/or speed/braking of vehicle 1924. For example, to avoid a collision, controller 1940 may automatically brake vehicle 1924 or redirect vehicle 1924.

Implement/attachment 1968 may be pushed, pulled or carried by vehicle 1924. Implement/attachment 1968 may interact with the environment and may be movable relative to vehicle 1924. Examples of implement/attachment include, but are not limited to, backhoes, blades, discs, plows, sprayers, fertilizer spreaders, cutting devices, trailers, planters, and the like. In response to or based upon the final estimate and/or a current estimate for the relative positioning of subject 1950 with respect to vehicle 1924, controller 1940 may output control signals causing an adjustment to the positioning of the implement/attachment 1968. For example, the implement/attachment 1968 may be moved to the left, moved to the right, raised or lowered based upon the final coordinate estimate or the relative positioning of subject 1950 with respect to vehicle 1924 and/or implement/attachment 1968.

In some implementations, controller 1940 may automatically output control signals causing the operation of implement/attachment 1968 to be adjusted based upon the final coordinate estimate for the relative positioning of subject 1950 with respect to vehicle 1924 and/or implement/attachment 1968. For example, in circumstances where the implement/attachment 1968 comprises a sprayer or spreader, the spraying or spreading pattern may be adjusted. In the example illustrated, the spray pattern 1974 is adjusted so be nonsymmetric, shortened on one side of implement/attachment 1968 based upon the positioning of subject 1950. In other implementations the depth at which the implement attachment 868 engages the ground, the speed at which the implement/attachment 1968 interacts with the environment (crops, trees, vines) and/or the rate at which materials are dispersed by implement/attachment 1968 may be adjusted.

Operator interface 1970 comprises a device by which an operator receives information from controller 1940. Operator interface 1970 may comprise a display screen, a speaker, a series of lights or the like. Operator interface 1970 may further comprise a device by which an operator may provide input or commands/selections to controller 1940. In some implementations, rather than automatically adjusting the speed, course or operation of vehicle 1924 or automatically adjusting the positioning or operation of implement/attachment 1968 based upon the location coordinates or the relative positioning of subject 1950 with respect to vehicle 1924, controller 1940 may first notify an operator of the recommended adjustment or change using operator interface 1970. The operator may then authorize or accept the recommended change or refuse the recommended change using an input component of operator interface 1970. The input component may be in the form of a touchscreen, a mouse, keyboard, touchpad, lever, pushbutton or other input mechanism. In some implementations, controller 1940 may output an alert to the operator of the current position of subject 1950 using operator interface 1970.

Alert interface 1972 comprise a device configured to output a visual or audible alert to persons or animals about vehicle 1924 or to subject 1950. Alert interface 1972 may comprise a light or set of lights (which may be flashed or provided with a warning color), a speaker, a horn or the like. In response to or based upon the final coordinate estimate for subject 1950 or the determined relative positioning of subject 1952 vehicle 1924, controller 1940 may output control signals causing alert interface 1972 to provide an alert to subject 1950 or other human or animals proximate to vehicle 1924. Such alerts may instruct the subject 1950 to move relative to vehicle 1924, may instruct those around vehicle 1924 to move subject 1950 or may frighten subject 1952 moving out of the upcoming path of vehicle 1924 and/are implement/attachment 1968. In some implementations, alert interface 1972 may be omitted.

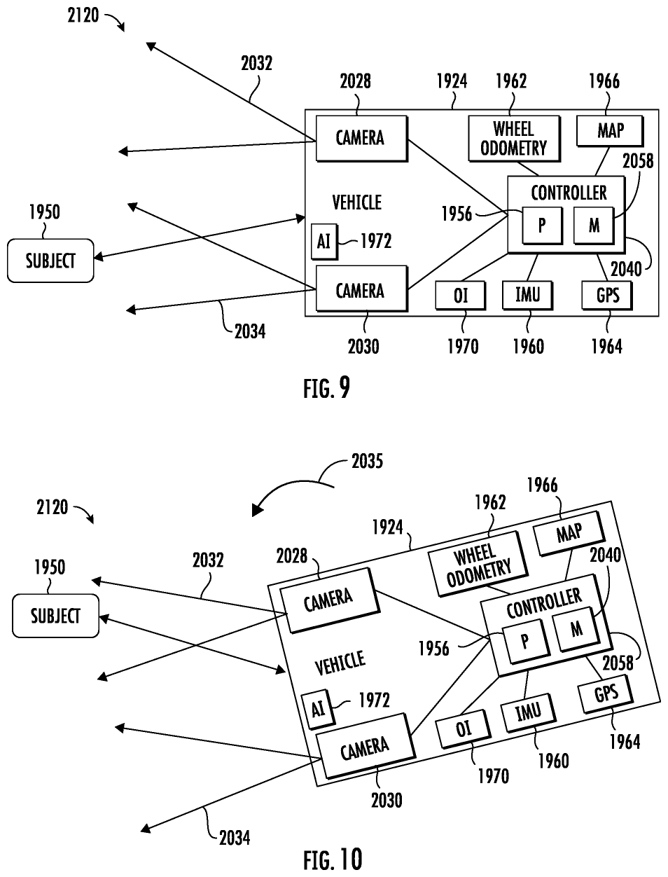

FIGS. 9 and 10 are diagrams schematically illustrating portions of an example monocular depth estimation system 2120. System 2120 is similar to system 1920 except that system 2120 comprises cameras 2028-1 and 2028-2 (collectively referred to as cameras 2028) in place of cameras 1928 and comprises controller 2040 having memory 2058 in place of memory 1958. Those remaining components of system 2120 which correspond to components of system 1920 are numbered similarly and/are our shown as described above with respect to system 1920. In some implementations, system 2320 may include the implement/attachment 1968 shown in FIG. 1.

Cameras 2028 are similar to cameras 1928 except that cameras 2028 do not have overlapping fields of view. Cameras 2028 have fields of view 2032 and 2034, respectively, which do not overlap. Although system 2120 is illustrated as including two cameras facing in forward directions proximate a front of vehicle 1924, in other implementations, cameras 2028 may be facing in other directions and provided at other locations of vehicle 1924. In other implementations, system 2120 may comprise additional cameras facing in various directions at other locations on vehicle 1924.

Memory 2058 is similar to memory 1958 except that memory 2058 comprises a non-transitory computer-readable medium including instructions configured to direct processor 1956 to perform the example monocular depth estimation method 2200 shown in FIG. 11. Method 2200 facilitates the estimation of coordinates of subject 1950 or the estimation of the relative positioning or depth of subject 1950 with respect to the cameras 2028 or vehicle 1924 using a pair of cameras that do not have overlapping fields of view. As indicated by block 2204, the instructions in memory 2058 of controller 2040 direct processor 1956 to acquire a first monocular image captured by camera 2030 containing subject 1950 while vehicle 1924 at a first vehicle location, the example vehicle location shown in FIG. 9.

As indicated by block 2208, the instructions in memory 2058 of controller 2040 direct processor 1956 to acquire a second monocular image captured by camera 2038 containing subject 1950 while vehicle 1924 at a second vehicle location, the example vehicle location shown in FIG. 10. In the first position shown in FIG. 9, the subject 1950 is within the field-of-view 2034 of camera 2030, but not within the field-of-view of camera 2028. In the second position shown in FIG. 10, the subject 1950 is within the field-of-view 2032 of camera 2028, but not within the field-of-view 2034 of camera 2030. Movement of the vehicle in the direction indicated by arrow 2035 moves vehicle 1924 such that subject 1950, at the same location, may be captured by each of the two different spaced cameras 2028.

As indicated by block 2212 in FIG. 11, controller 240 determines a first initial estimate of the coordinates of the location of subject 1950 based upon the first monocular image captured in block 2204. Such a determination may be made as described above with respect to FIGS. 5-8. As indicated by block 2216, controller 240 also determines a second initial estimate for the coordinates of the location of subject 1950 based upon the second monocular image captured in block 2208. Again, such a determination may be made according to the process shown and described above with respect to FIGS. 5-8.

As indicated by block 2218, controller 2040 determines a final estimate for the coordinates of the location of subject 1950 based upon (1) the first initial estimate termed in block 2012, (2) the second initial estimate determined in block 2216, (3) a difference between the first vehicle location and the second vehicle location, and (4) a predetermined distance between the first camera 2028-1 and the second camera 2028-2. As discussed above with respect to system 1920, this final estimate for the coordinates of subject 1950 may be adjusted or recalculated based upon the roll, pitch or yaw of vehicle 1924 at the times that cameras 1928 captured the monocular images of subject 1950. The determined depth or spacing of subject 1950 relative to vehicle 1924 may be further adjusted based upon an estimated motion of vehicle 1924 and/or subject 1950 based upon signals from cameras 2028, wheel odometry 1962 and/or GPS 1964. The determined final estimate for the coordinates or relative spacing of subject 1950 may be used as a basis for adjusting or controlling the course and speed of vehicle 1924, the positioning of implement/attachment 1968, the operation of implement/attachment 1968, the output of a notification or alert by operator interface 1970 and/or the output of a notification alert by alert interface 1972.

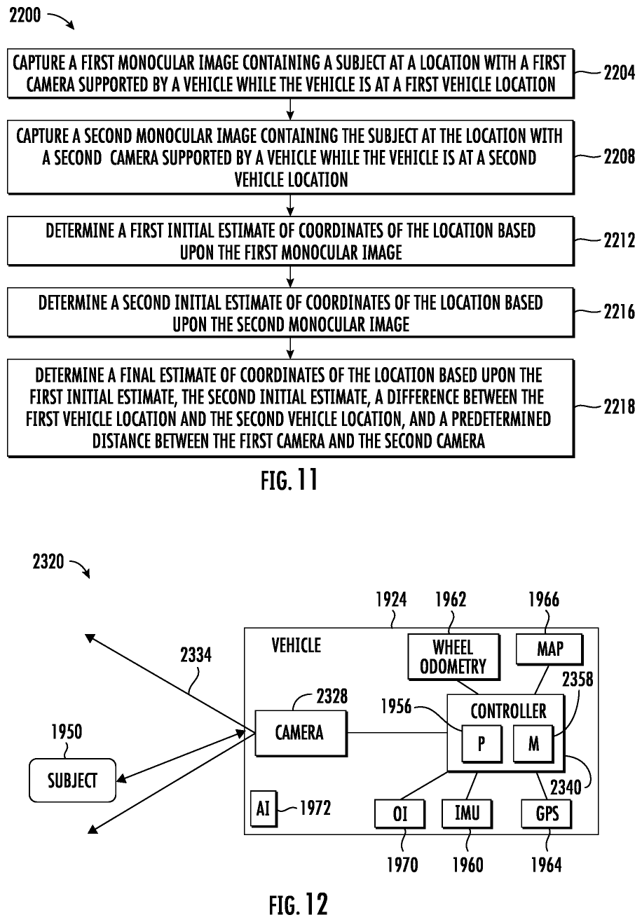

FIGS. 12 and 13 are diagrams schematically illustrating portions of an example monocular depth estimation system 2320. System 2320 is similar to system 1920 except that system 2320 comprises a single camera 2328 in place of cameras 1928 and comprises controller 2340 having memory 2358 in place of memory 1958. Those remaining components of system 2320 which correspond to components of system 1920 are numbered similarly and/are our shown as described above with respect to system 1920. In some implementations, system 2320 may include the implement/attachment 1968 shown in FIG. 1.

Camera 2328 is supported by vehicle 1924. Camera 2328 may comprise a monocular camera or may comprise a stereo camera operating in a monocular image capturing mode. Although system 2320 is illustrated as including a single camera facing in forward directions proximate a front of vehicle 1924, in other implementations, camera 2328 may be facing in other directions and provided at other locations of vehicle 1924. In other implementations, system 2320 may comprise additional cameras facing in various directions at other locations on vehicle 1924, wherein the monocular depth estimation or subject coordinate estimation is determined using a single selected one of the available cameras.

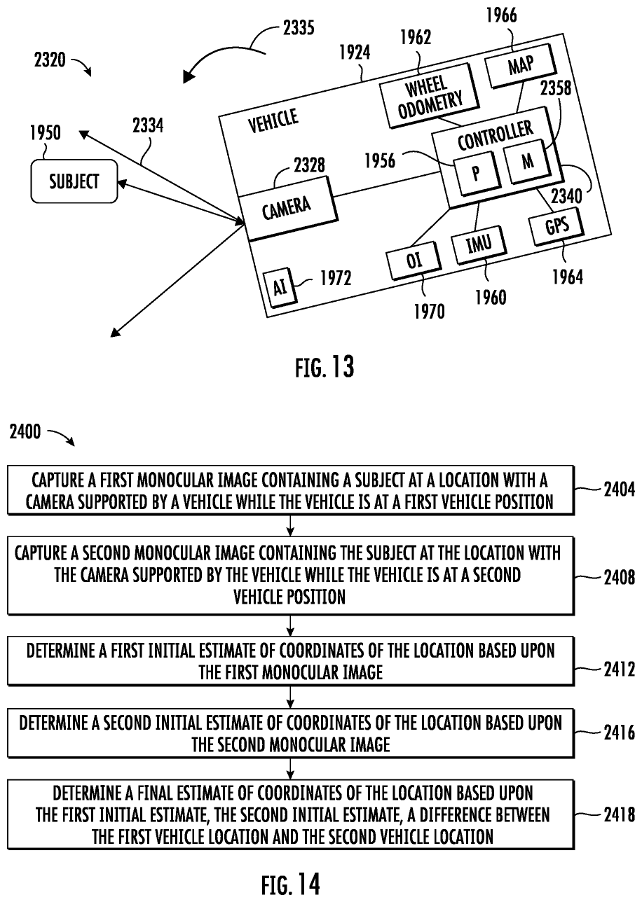

Memory 2358 is similar to memory 1958 except that memory 2358 comprises a non-transitory computer-readable medium including instructions configured to direct processor 1956 to perform the example monocular depth estimation method 2400 shown in FIG. 14. Method 2200 facilitates the estimate of coordinates of subject 1950 or the estimation of the relative positioning or depth of subject 1950 with respect to the camera 2328 or vehicle 1924 using a single camera. As indicated by block 2404, the instructions in memory 2058 of controller 2340 directs processor 1956 to acquire a first monocular image captured by camera 2328 containing subject 1950 while vehicle 1924 at a first vehicle location, the example vehicle location shown in FIG. 12.

As indicated by block 2408, the instructions in memory 2358 of controller 2340 direct processor 1956 to acquire a second monocular image captured by camera 2328 containing subject 1950 while vehicle 1924 is at a second vehicle location, the example vehicle location shown in FIG. 13. In the first position shown in FIG. 12, the subject 1950 is at a location having a first relationship to camera 2328. In the second vehicle position shown in FIG. 13, the subject 1950 is at the same location having a second relationship to camera 2328. Movement of the vehicle 1924 in the direction indicated by arrow 2335 moves vehicle 1924 such that subject 1950, at the same location, may be captured by the single camera 2328 while the vehicle is at the two different vehicle locations.

As indicated by block 2412 in FIG. 12, controller 2340 determines a first initial estimate of the coordinates of the location of subject 1950 based upon the first monocular image captured in block 2404. Such a determination may be made as described above with respect to FIGS. 5-8. As indicated by block 2416, controller 2340 also determines a second initial estimate for the coordinates of the location of subject 1950 based upon the second monocular image captured in block 2408. Again, such a determination may be made according to the process shown and described above with respect to FIGS. 5-8.

As indicated by block 2418, controller 2340 determines a final estimate for the coordinates of the location of subject 1950 based upon (1) the first initial estimate determined in block 2412, (2) the second initial estimate determined in block 2416, and (3) a difference between the first vehicle location and the second vehicle location. As discussed above with respect to system 1920, this final estimate for the coordinates of subject 1950 may be adjusted or recalculated based upon the roll, pitch or yaw of vehicle 1924 at the times that camera 2328 captured the monocular image containing subject 1950. The determined depth or spacing of subject 1950 relative to vehicle 1924 may be further adjusted based upon an estimated motion of vehicle 1924 and/or subject 1950 based upon signals from camera 2328, wheel odometry 1962 and/or GPS 1964. The determined final estimate for the coordinates or relative spacing of subject 1950 may be used as a basis for adjusting or controlling the course and speed of vehicle 1924, the positioning of implement/attachment 1968, the operation of implement/attachment 1968, the output of a notification or alert by operator interface 1970 and/or the output of a notification alert by alert interface 1972.

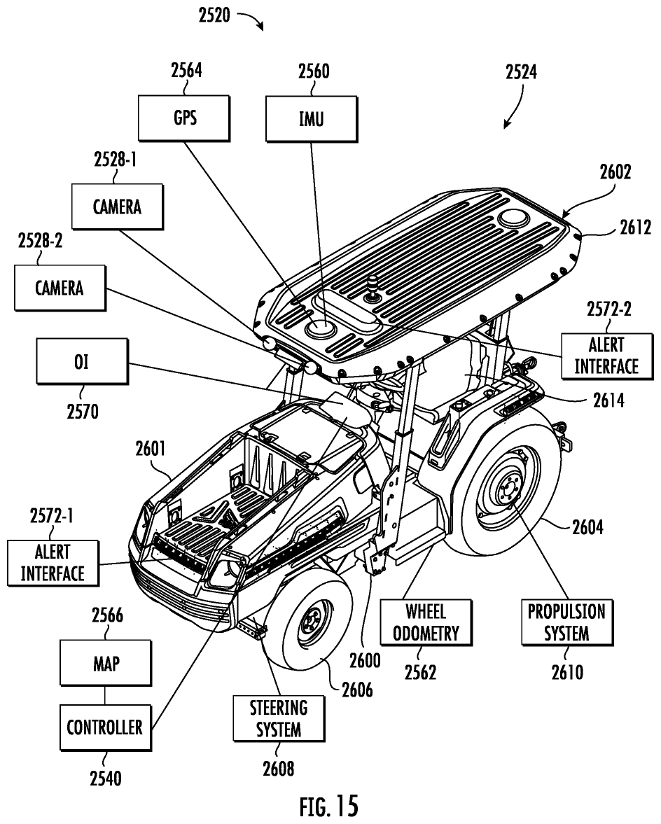

FIG. 15 is a perspective view illustrating portions of an example monocular depth estimation system 2520. FIG. 15 illustrates one example implementation of system 1920, system 2120 or system 2320 described above. System 2520 comprises a vehicle 2524 in the form of a tractor. Vehicle 2524 comprises frame 2600, operator cab 2602, rear wheels 2604, steered front wheels 2606, steering system 2608, propulsion system 2610, cameras 2528-1, 2528-2 (collectively referred to as cameras 2528), and controller 2540.

Frame 2600 forms part of a chassis and supports the remaining components of vehicle 2524. Operator cab 2602 is supported by frame 2600 and comprises roof 2612 and operator seat 2614. Roof 2612 extends above the operator seat 2614. Operator seat 2614 provides a seat for an operator to reside during manual steering or operation of vehicle 2524.

Rear wheels 2604 engage the underlying terrain or ground to drive vehicle 2524. In some implementations, rear wheels 2604 may be replaced with tracks. In some implementations, rear wheels 2604 receive torque from an electric motor which is transmitted to rear wheels 2604 by transmission. In some implementations, rear wheels 2604 receive torque from an internal combustion engine or a hybrid between an internal combustion engine and an electric motor, wherein the torque is transmitted by a transmission to rear wheels 2604.

Steered front wheels 2606 comprise steerable wheels that may be turned to steer or control the direction of vehicle 2524. In some implementations, the angular positioning of steered front wheels 2606 is controlled by a steer by wire system, wherein a steering actuator (hydraulic jack, electric solenoid or the like) interacts upon a rack gear or other gearing system based upon electronic signals received from controller 2540. In some implementations, steered front wheels 2606 may alternatively comprise tracks. In some implementations, steered front wheels 2606 may be powered to control their rotation relative to the rotation of rear wheels 2604. For example, in some implementations, front steered wheels 2606 may be driven by a hydraulic motor which is driven by a hydraulic pump that is driven by the electric motor.

Steering system 2608 (schematically illustrated) may comprise a set of gears, belts or other mechanisms configured to controllably rotate or steer wheels 1256. In some implementations, steering system 2608 may be a steer by wire system having an actuator such as an electric solenoid or hydraulic jack (cylinder-piston assembly) that controllably turns or steers wheels 1256. In some implementations, steering system 2608 may include a rack and pinion steering system. Steering system 2608 actuates or turns wheels 1256 based upon steering control signals received from controller 2540 of vehicle 2524.

Propulsion system 2610 (schematically illustrated) propels or drives vehicle 2524 in forward and rearward directions. In some implementations, propulsion system 2610 may comprise an internal combustion engine that outputs torque which is transmitted via a transmission to rear wheels of vehicle 2524. In some implementations, propulsion system 2610 comprises an electric motor that outputs torque which is transmitted via a transmission to rear wheels of vehicle 2524. In some implementations, propulsion system 2610 may comprise a hydraulic motor driven by a hydraulic pump which is driven by the electric motor, wherein the hydraulic motor drives front wheels 2606 to control a lead of such front wheels 2606. In some implementations, system 2610 may comprise a hybrid system. As should be appreciated, each of the vehicles described in this disclosure may include both the above-described steering system 2608 and the above-described propulsion system 2610.

Cameras 2528 may be similar to cameras 1928 described above. Cameras 2528 may comprise spaced cameras supported at a front of roof 2612 and configured to capture monocular images of regions in front of vehicle 2524. In the example illustrated, cameras 2528 face in a forward direction proximate a front of vehicle 2524, wherein the cameras 2528 have overlapping fields of view. In other implementations, cameras 2528 may be provided at other locations on vehicle 2524, wherein the cameras have overlapping fields of view. For example, cameras 2528 may alternatively be rearwardly facing cameras or sideways facing cameras. In some implementations, system 2520 may comprise additional cameras which also have overlapping fields of view.

Controller 2540 is similar to controller 1940 described above. Controller 2540 comprises a memory 1958 containing instructions to direct processor 1956 to carry out method 2000 described above with respect to FIG. 2. In some implementations, memory 1958 may comprise instructions configured direct processor 1956 to operate under different operator selectable modes, wherein system method 2200 or method 2400 described above. As described above, controller 2540 may utilize the final estimate of the coordinates of the location of the subject 1950 as a basis for outputting control signals that control or adjust the speed of vehicle 2524 being provided by propulsion system 2610 and/or the steering of vehicle 2524 being provided by steering system 2608. Based upon the final estimate of the coordinates of the location of the subject 1950, controller 2540 may further output signals causing alert interface 2572 to alert to subject 1950. In some implementations, controller 2540 may further output control signals to adjust the operation of implement/attachment 1968 (shown in FIG. 1) as described above based upon the final estimate of the coordinates of location of the subject 1950.

As shown by FIG. 15, in some implementations, system 2520 may additionally comprise inertial measurement unit 2560, wheel odometry 2562 and GPS receiver 2564. Each of such facilitate an adjustment to the final estimate for the coordinates of the location of subject 1950 as determined in block 2018 of FIG. 2. Inertial measurement unit 2560 may comprise accelerometers and a gyroscope. Inertial measurement unit 2560 may output signals indicating a current roll, pitch and/or yaw of vehicle 2524.

Controller 2540 may determine the roll, pitch and/or yaw of vehicle 2524 at the time of the capture of the monocular images by cameras 2528 and to adjust the final estimate for the coordinates of the location of subject 1950 based upon the roll, pitch and/or yaw of vehicle 2524 at the time of image capture. In some implementations, this adjustment may comprise adjusting the first and the second initial estimates determined in block 2012 and 2016 based upon the then roll, pitch and/are yaw of vehicle 2524 and determining a new final estimate using the adjusted first and second initial estimates. In some implementations, this adjustment may comprise directly adjusting the previously determined final estimate based upon the roll, pitch and/or yaw of vehicle 2524 at the time of image capture. In some implementations, system 2520 may utilize more than one inertial measurement unit for providing signals roll, pitch or yaw vehicle 2524. In some implementations, inertial measurement unit 2560 may be omitted.

Wheel odometry 2562, GPS 2564 and images provided by cameras 2528 at different points in time, may further be utilized by controller 2540 to determine or estimate motion of vehicle 2524. Such motion of vehicle 2524 may have occurred following the capture of the first and second monocular images in blocks 2004 and 2008. Such motion may impact the relative spacing or depth of subject 1954 with respect to vehicle 2524. For example, the final estimate determined in block 2018 may indicate that subject 1950 is at a first distance from vehicle 2524. However, subsequent motion of vehicle 2524 may result in subject 1950 being closer or farther away from vehicle 2524. Based upon the determined motion of vehicle 2524 following the final estimate determination in block 2018, controller 2540 may adjust an estimated spacing or depth of subject 1950. This adjustment may result in more appropriate timely vehicle responses based upon the adjusted depth or location of subject 1950 relative to vehicle 2524.

In some implementations, in lieu of sensing vehicle motion following the final estimate determined in block 2018, controller 2540 may adjust an estimated depth of subject 1950 or spacing of subject 1950 from vehicle 2524 based upon an autonomous program or routine that is controlling the steering and speed of vehicle 2524. For example, vehicle 2524 may be autonomously driven on a particular predefined course and at a particular predefined speed or set of speeds pursuant to a routine or program contained in memory 1958 or received by controller 2540 from a remote location. The program or routine may control the steering speed of vehicle 1924 based on elapsed time since the beginning of the routine or the current geographic location of vehicle 2524, as determined from signals from GPS 2564. Using such information, controller 2540 may determine or estimate the distance and direction traveled by vehicle 2524 for the period of time following the final estimate determination in block 2018. The distance and direction traveled by vehicle 2524 in combination with the earlier determined final estimate determined in block 2018 may be utilized by controller to determine the actual current spacing or relative positioning of subject 1950 with respect to vehicle 2524.

In response to or based upon the current coordinates of subject 1950 and/or the current spacing or relative positioning of subject 1950 with respect to vehicle 2524, controller 2540 may carry out any one of multiple various responsive actions, such as mapping, steering and/or speed adjustments, operational adjustments and/or notifications/alerts, As schematically shown in FIG. 15, system 2520 may additionally comprise map 2566, implement/attachment 1968 (schematically shown in FIG. 1), operator interface 2570 and alert interfaces 2572-1, 2572-2 (collectively referred to as alert interfaces 2572).

In some implementations, upon determining the estimated coordinates for the location of subject 1950, controller 2540 may map such coordinates, resulting in map 2566. In circumstances where subject 1950 may be permanent in nature or not subject to change, such mapping may be useful for subsequent control of vehicle 2524 at future times. Map 2566 may be stored either locally on vehicle 2524 or at a remote location, wherein the coordinates and/or the map are transmitted in a wireless fashion to a remote server. In some implementations, such mapping may be omitted.

In response to or based upon the final estimate and/or the current estimate for the relative positioning of subject 1950 with respect to vehicle 2524, controller 2540 may automatically adjust the current course and/or speed/braking of vehicle 2524. For example, to avoid a collision, controller 2540 may automatically brake vehicle 2524 or redirect vehicle 2524.

Implement/attachment 1968 may be pushed, pulled or carried by vehicle 2524. Implement/attachment 1968 may interact with the environment and may be movable relative to vehicle 2524. Examples of implement/attachment include, but are not limited to, backhoes, blades, discs, plows, sprayers, fertilizer spreaders, cutting devices, trailers, planters, and the like. In response to or based upon the final estimate and/or a current estimate for the relative positioning of subject 1950 with respect to vehicle 2524, controller 2540 may output control signals causing an adjustment to the positioning of the implement/attachment 1968. For example, the implement/attachment 1968 may be moved to the left, moved to the right, raised or lowered based upon the final coordinate estimate or the relative positioning of subject 1950 with respect to vehicle 2524 and/or implement/attachment 1968.

In some implementations, controller 2540 may automatically output control signals causing the operation of implement/attachment 1968 to be adjusted based upon the final coordinate estimate for the relative positioning of subject 1950 with respect to vehicle 2524 and/or implement/attachment 1968. For example, in circumstances where the implement/attachment 1968 comprises a sprayer or spreader, the spraying or spreading pattern may be adjusted. In the example illustrated, the spray pattern may be adjusted so be nonsymmetric, shortened on one side of implement/attachment 1968 based upon the positioning of subject 1950. In other implementations the depth at which the implement attachment 1968 engages the ground, the speed at which the implement/attachment 1968 interacts with the environment (crops, trees, vines) and/or the rate at which materials are dispersed by implement/attachment 1968 may be adjusted.

Alert interfaces 2572 comprise devices configured to output a visual or audible alert to persons or animals about vehicle 2524 or to subject 1950. Alert interface 2572 may comprise a light or set of lights (which may be flashed or provided with a warning color), a speaker, a horn or the like. In response to or based upon the final coordinate estimate for subject 1950 or the determined relative positioning of subject 1952 vehicle 2524, controller 2540 may output control signals causing alert interface 2572 to provide an alert to subject 1950 or other human or animals proximate to vehicle 2524. Such alerts may instruct the subject 1950 to move relative to vehicle 1924, may instruct those around vehicle 2524 to move subject 1950 or may frighten subject 1952 moving out of the upcoming path of vehicle 2524 and/are implement/attachment 1968.

In the example illustrated, alert interface 2572 2-1 comprises a light bar, such as a series of light-emitting diode, extending along a front face of hood 2601 of frame 2600. Alert interface 2572-2 comprises a light or beacon supported on top of roof 2612. Each of such alert interfaces 2572 may be illuminated with different colors, different brightness is or flash with different frequencies to communicate to subject 1950 or those around subject 1950 of the impending or potential encounter. In some implementations, alert interfaces 1972 may be audible devices, may be divided at other locations or may be omitted.

Although the claims of the present disclosure are generally directed to estimating coordinates of the location of the subject based upon images captured at multiple vantage points from a vehicle and a spacing between the vantage points when the images were captured, the present disclosure is additionally directed to the features set forth in the following definitions.
Definition 1. A monocular depth estimation system comprising:
   a vehicle;
   a first camera supported at a first position on the vehicle;
   a second camera supported at a second position on the vehicle, the first camera and the second camera having overlapping fields of view;
   a processing resource;
   a non-transitory computer readable medium comprising instructions configured to direct a processing resource to:
      capture a first monocular image containing a subject at a location with the first camera;
      capture a second monocular image containing the subject at the location with the second camera;
      determine a first initial estimate of coordinates of the location based upon the first monocular image;
      determine a second initial estimate of coordinates of the location based upon the second monocular image; and
      determine a final estimate of coordinates of the location based upon the first initial estimate, the second initial estimate and a predetermined distance between the first camera and the second camera.
Definition 2. The system of Definition 1, wherein the instructions are further configured to direct the processing resource to determine an adjusted estimate of coordinates of the subject based upon the final estimate of coordinates and at least one of a motion of the vehicle and an estimated motion of the subject.
Definition 3. The system of Definition 2, wherein the instructions are further configured to direct the processing resource to determine the adjusted estimate of coordinates of the subject additionally based upon at least one of a roll and a yaw of the vehicle.
Definition 4. The system of Definition 3 further comprising an inertial measurement unit carried by the vehicle, wherein the instructions are configured to estimate at least one of the roll and the yaw of the vehicle based upon signals from the inertial measurement unit.
Definition 5. The system of any of Definitions 2-4, wherein the instructions are configured to estimate the motion of the subject based upon the final estimate of coordinates and earlier final estimate of coordinates.
Definition 6. The system of Definition 1, wherein the instructions are further configured to determine an adjusted estimate of coordinates of the subject based upon the final estimate of coordinates and at least one of a roll and a yaw of the vehicle.
Definition 7. The system of Definition 6 further comprising an inertial measurement unit carried by the vehicle, wherein the instructions are configured to direct the processing resource to estimate at least one of the roll and the yaw of the vehicle based upon signals from the inertial measurement unit.
Definition 8. The system of any of Definitions 1-7 further comprising a global positioning satellite (GPS) system receiver carried by the vehicle, wherein the instructions are further configured to direct the processing resource to determine geographic coordinates of the subject based upon the final estimate of coordinates and to store the geographic coordinates of the subject.
Definition 9. The system of Definition 8, wherein the instructions are configured to direct the processing resource to map the subject based upon the geographic coordinates of the subject.
Definition 10. The system of any of Definitions 1-9, wherein the instructions are configured to direct the processing resource to output control signals autonomously controlling a steering of the vehicle based upon the final estimate of coordinates of the subject.
Definition 11. The system of any of Definitions 1-10, wherein the instructions are configured to direct the processing resource to output control signals autonomously controlling a speed/braking of the vehicle based upon the final estimate of coordinates of the subject.
Definition 12. The system of any of Definitions 1-11, wherein the instructions are configured to direct the processing resource to determine the final estimate of coordinates of the subject in real time.
Definition 13. The system of any of Definitions 1-12, wherein the instructions are configured to direct the processing resource to output control signals causing an alert to be output to a vehicle operator based upon the final estimate of coordinates of the subject.
Definition 14. The system of Definition 13, wherein the instructions are configured direct the processing resource to output the control signals causing the alert to be output to the vehicle operator additionally based upon a current speed or travel direction of the vehicle.
Definition 15. The system of Definition 1, wherein the instructions are configured to direct the processing resource to control operation of an attachment or implement carried by the vehicle based upon the final estimate of coordinates of the subject.
Definition 16. The system of Definition 1, wherein the instructions are configured to direct the processing resource to control positioning of an attachment or implement carried by the vehicle, relative to the vehicle, based upon the final estimate of coordinates of the subject.
Definition 17. The system of Definition 11, wherein the instructions are configured direct the processing resource to output the control signals causing an alert to be output to the subject based upon the final estimate of coordinates of the subject.
Definition 18. The system of Definition 17, wherein the instructions are configured direct the processing resource to output the control signals causing the alert to be output to the subject additionally based upon a current speed or travel direction of the vehicle.
Definition 19. A monocular depth estimation system comprising:
   a vehicle;
   a first camera supported at a first position on the vehicle;
   a second camera supported at a second position on the vehicle;
a processing resource;
a non-transitory computer readable medium comprising instructions configured to direct the processing resource to:
   capture a first monocular image containing a subject at a location with the first camera while the vehicle is at a first vehicle location;
   capture a second monocular image containing the subject at the location with the second camera while the vehicle is at a second vehicle location;
   determine a first initial estimate of coordinates of the location based upon the first monocular image;
   determine a second initial estimate of coordinates of the location based upon the second monocular image; and
   determine a final estimate of coordinates of the location based upon the first initial estimate, the second initial estimate, a difference between the first vehicle location and the second vehicle location, and a predetermined distance between the first camera and the second camera.
Definition 20. The system of Definition 19, wherein the instructions are further configured to direct the processing resource to determine an adjusted estimate of coordinates of the subject based upon the final estimate of coordinates and at least one of a motion of the vehicle and an estimated motion of the subject.
Definition 21. The system of Definition 20, wherein the instructions are further configured to direct the processing resource to determine the adjusted estimate of coordinates of the subject additionally based upon at least one of a roll and a yaw of the vehicle.
Definition 22. The system of Definition 21 further comprising an inertial measurement unit carried by the vehicle, wherein the instructions are configured to estimate at least one of the roll and the yaw of the vehicle based upon signals from the inertial measurement unit.
Definition 23. The system of any of Definitions 2-22, wherein the instructions are configured to estimate the motion of the subject based upon the final estimate of coordinates and earlier final estimate of coordinates.
Definition 24. The system of Definition 19, wherein the instructions are further configured to determine an adjusted estimate of coordinates of the subject based upon the final estimate of coordinates and at least one of a roll and a yaw of the vehicle.
Definition 25. The system of Definition 24 further comprising an inertial measurement unit carried by the vehicle, wherein the instructions are configured to direct the processing resource to estimate at least one of the roll and the yaw of the vehicle based upon signals from the inertial measurement unit.
Definition 26. The system of any of Definitions 19-25 further comprising a global positioning satellite (GPS) system receiver carried by the vehicle, wherein the instructions are further configured to direct the processing resource to determine geographic coordinates of the subject based upon the final estimate of coordinates and to store the geographic coordinates of the subject.
Definition 27. The system of Definition 26, wherein the instructions are configured to direct the processing resource to map the subject based upon the geographic coordinates of the subject.
Definition 28. The system of any of Definitions 19-27, wherein the instructions are configured to direct the processing resource to output control signals autonomously controlling a steering of the vehicle based upon the final estimate of coordinates of the subject.
Definition 29. The system of any of Definitions 19-28, wherein the instructions are configured to direct the processing resource to output control signals autonomously controlling a speed/braking of the vehicle based upon the final estimate of coordinates of the subject.
Definition 30. The system of any of Definitions 19-29, wherein the instructions are configured to direct the processing resource to determine the final estimate of coordinates of the subject in real time.
Definition 31. The system of any of Definitions 19-3, wherein the instructions are configured to direct the processing resource to output control signals causing an alert to be output to a vehicle operator based upon the final estimate of coordinates of the subject.
Definition 32. The system of Definition 31, wherein the instructions are configured direct the processing resource to output the control signals causing the alert to be output to the vehicle operator additionally based upon a current speed or travel direction of the vehicle.
Definition 33. The system of Definition 19, wherein the instructions are configured to direct the processing resource to control operation of an attachment or implement carried by the vehicle based upon the final estimate of coordinates of the subject.
Definition 34. The system of Definition 19, wherein the instructions are configured to direct the processing resource to control positioning of an attachment or implement carried by the vehicle, relative to the vehicle, based upon the final estimate of coordinates of the subject.
Definition 35. The system of Definition 29, wherein the instructions are configured direct the processing resource to output the control signals causing an alert to be output to the subject based upon the final estimate of coordinates of the subject.
Definition 36. The system of Definition 35, wherein the instructions are configured direct the processing resource to output the control signals causing the alert to be output to the subject additionally based upon a current speed or travel direction of the vehicle.
Definition 37. A monocular depth estimation system comprising:
   a vehicle;
   a camera supported at a first position on the vehicle;
   a processing resource;
   a non-transitory computer readable medium comprising instructions configured to direct the processing resource to:
      capture a first monocular image containing a subject at a location with the camera while the vehicle is at a first vehicle location;
      capture a second monocular image containing the subject at the location with the camera while the vehicle is at a second vehicle location;
      determine a first initial estimate of coordinates of the location based upon the first monocular image;
      determine a second initial estimate of coordinates of the location based upon the second monocular image; and
   determine a final estimate of coordinates of the location based upon the first initial estimate, the second initial estimate, and a difference between the first vehicle location and the second vehicle location.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A monocular depth estimation system comprising:
a non-transitory computer readable medium comprising instructions configured to direct a processing resource to:
capture a first monocular image from a vehicle, the first monocular image containing a subject at a location from a first vantage point;
capture a second monocular image from the vehicle, the second monocular image containing the subject at the location from a second vantage point;
determine a first initial estimate of coordinates of the location based upon the first monocular image;
determine a second initial estimate of coordinates of the location based upon the second monocular image; and
determine a final estimate of coordinates of the location based upon the first initial estimate, the second initial estimate and a distance between the first vantage point and the second vantage point.

2. The monocular depth estimation system of claim 1 further comprising:
the vehicle;
a first camera supported at a first position on the vehicle;
a second camera supported at a second position on the vehicle, the first camera and the second camera having overlapping fields of view;
a processing resource, and
a non-transitory computer-readable medium containing instructions, wherein the instructions are configured to direct the processing resource to:
capture the first monocular image containing the subject at the location with the first camera at the first vantage point; and
capture the second monocular image containing the subject at the location with the second camera at the second vantage point.

3. The system of claim 1, wherein the instructions are further configured to direct the processing resource to determine an adjusted estimate of coordinates of the subject based upon the final estimate of coordinates and at least one of a motion of the vehicle and an estimated motion of the subject.

4. The system of claim 3, wherein the instructions are further configured to direct the processing resource to determine the adjusted estimate of coordinates of the subject additionally based upon at least one of a roll and a yaw of the vehicle.

5. The system of claim 4 further comprising an inertial measurement unit carried by the vehicle, wherein the instructions are configured to estimate at least one of the roll and the yaw of the vehicle based upon signals from the inertial measurement unit.

6. The system of claim 1, wherein the instructions are configured to estimate motion of the subject based upon the final estimate of coordinates and earlier final estimate of coordinates.

7. The system of claim 1, wherein the instructions are further configured to determine an adjusted estimate of coordinates of the subject based upon the final estimate of coordinates and at least one of a roll and a yaw of the vehicle.

8. The system of claim 6 further comprising an inertial measurement unit carried by the vehicle, wherein the instructions are configured to direct the processing resource to estimate at least one of roll and yaw of the vehicle based upon signals from the inertial measurement unit.

9. The system of claim 1 further comprising a global positioning satellite (GPS) system receiver carried by the vehicle, wherein the instructions are further configured to direct the processing resource to determine geographic coordinates of the subject based upon the final estimate of coordinates and to store the geographic coordinates of the subject.

10. The system of claim 9, wherein the instructions are configured to direct a processing resource to map the subject based upon the geographic coordinates of the subject.

11. The system of claim 1, wherein the instructions are configured to direct a processing resource to output control signals autonomously controlling a steering of the vehicle based upon the final estimate of coordinates of the subject.

12. The system of claim 1, wherein the instructions are configured to direct a processing resource to output control signals autonomously controlling a speed/braking of the vehicle based upon the final estimate of coordinates of the subject.

13. The system of claim 1, wherein the instructions are configured to direct the processing resource to determine the final estimate of coordinates of the subject in real time.

14. The monocular depth estimation system of claim 1 further comprising:
the vehicle;
a first camera supported at a first position on the vehicle;
a second camera supported at a second position on the vehicle;
a processing resource; and
a non-transitory computer-readable medium containing instructions, wherein the instructions are configured to direct the processing resource to:
capture the first monocular image containing a subject at the location with the first camera while the vehicle is at a first vehicle location;
capture the second monocular image containing the subject at the location with the second camera while the vehicle is at a second vehicle location.

15. The monocular depth estimation system of claim 1 further comprising:
a vehicle;
a camera supported at a first position on the vehicle;
a processing resource; and
a non-transitory computer-readable medium containing instructions, wherein the instructions are configured to direct the processing resource to:
capture the first monocular image containing a subject at a location with the camera while the vehicle is at a first vehicle location;
capture the second monocular image containing the subject at the location with the camera while the vehicle is at a second vehicle location.

16. The monocular depth estimation system of claim 1, wherein the instructions are configured to direct the processing resource to control operation of an attachment or implement carried by the vehicle based upon the final estimate of coordinates of the subject.

17. The monocular depth estimation system of claim 1, wherein the instructions are configured to direct the processing resource to control positioning of an attachment or implement carried by the vehicle, relative to the vehicle, based upon the final estimate of coordinates of the subject.

18. The monocular depth estimation system of claim 1, wherein the instructions are configured direct the processing resource to output the control signals causing an alert to be output to the subject based upon the final estimate of coordinates of the subject.

19. The monocular depth estimation system of claim 18, wherein the instructions are configured direct the processing resource to output the control signals causing the alert to be output to the subject additionally based upon a current speed or travel direction of the vehicle.

20. A monocular depth estimation method comprising:
capturing a first monocular image from a vehicle, the first monocular image containing a subject at a location from a first vantage point;
capturing a second monocular image from the vehicle, the second monocular image containing the subject at the location from a second vantage point;
determining a first initial estimate of coordinates of the location based upon the first monocular image;
determining a second initial estimate of coordinates of the location based upon the second monocular image;
determining a final estimate of coordinates of the location based upon the first initial estimate, the second initial estimate and a distance between the first vantage point and the second vantage point; and
autonomously control the vehicle based up the final estimate of coordinates of the location.
